(19) United States
(12) Patent Application Publication
(10) Pub. No.: US 2021/0325031 A1
(43) Pub. Date: Oct. 21, 2021

(54) FENCE POST CAP

(71) Applicant: Robert Wilson, Windsor, CA (US)

(72) Inventor: Robert Wilson, Windsor, CA (US)

(21) Appl. No.: 16/849,699

(22) Filed: Apr. 15, 2020

(51) Int. Cl. F21V 33/00; E04H 17/20; F21S 9/03; F21V 23/04

(52) U.S. Cl. CPC F21V 33/006; E04H 17/20; E04H 2017/006; F21V 23/0471; F21S 9/037

(57) ABSTRACT

A fence post cap for protecting a top portion of a wood fence post is provided. The fence post cap includes a square base member having a front side, rear side, a left side, and rear side. The base member is hollow. A top surface is positioned on the base member, wherein the top surface essentially consists of a single slope. A perpendicular plane extending from the front side to the top surface defining an angle. A number of holes provided on the base member enabling a number of fastening elements to pass through the number of holes such that the fence post cap is enabled to be secured to the wood fence post. The fence post cap may include an optional lighting system. The fence post may be constructed from a variety of materials and colors.

### CROSS-REFERENCE TO RELATED APPLICATIONS

N/A

### BACKGROUND OF THE INVENTION

### 1. Field of the Invention

The present invention relates to fence post preservation and more particularly a fence post cap.

### 2. Description of Related Art

Wood fences are a common additional to home properties. The wood fences utilize posts to stabilize the fence. It is well known in the art that the top portion of a fence post, i.e. the end grain is the most vulnerable part of the fence post. In wet environments, this portion of the fence post will absorb more water than any other part of the fence post. The absorbed water will lead to mold, mildew, and rot. Furthermore, the top portions of the fence post are exposed to sun and wind, which dries the wood and causes it to crack. To prevent the issues discussed above, a fence post cap may be installed on the fence post.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In order to do so, in one aspect of the invention, a fence post cap is provided, comprising a base member having a front side, rear side, a left side, and rear side, wherein the base member is hollow; a single top sloped surface, wherein the single top sloped surface is pitched from the front side to the rear side; an angle defined from a perpendicular plane extending from the front side to the single top sloped surface; and, a number of holes is provided on the base member enabling a number of fastening elements to pass through the number of holes such that the fence post cap is enabled to be secured to a wood fence post.

In one embodiment, a lighting system is provided, wherein the lighting system comprises a solar panel consisting of a number of photo-voltaic modules, a number of LED lights, a battery, and a motion sensor. In one embodiment, the solar panel is positioned on the single top sloped surface. In another embodiment, the LED lights and motion sensor are positioned on the front side of the base member. In one embodiment, the fence post cap is constructed of aluminum, plastic, or copper. In one embodiment, the base member is square. In another embodiment, wherein the angle ranges from 25 to 45 degrees.

In another aspect of the invention, a fence post cap for protecting a top portion of a wood fence post is provided, the fence post cap comprising a square base member having a front side, rear side, a left side, and rear side, wherein the base member is hollow; a top surface is positioned on the base member, wherein the top surface essentially consists of a single slope; an angle defined from a perpendicular plane extending from the front side to the top surface; and, a number of holes is provided on the base member enabling a number of fastening elements to pass through the number of holes such that the fence post cap is enabled to be secured to the wood fence post.

In one embodiment, a lighting system is provided, wherein the lighting system comprises a solar panel consisting of a number of photo-voltaic modules, a number of LED lights, a battery, and a motion sensor. In one embodiment, the solar panel is positioned on the single top sloped surface. In another embodiment, the LED lights and motion sensor are positioned on the front side of the base member. In one embodiment, the fence post cap is constructed of aluminum, plastic, or copper. In another embodiment, wherein the angle ranges from 25 to 45 degrees.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a fence post cap installed on a post according to an embodiment of the present invention.

FIG. 2 is a front, right perspective view of the fence post cap according to an embodiment of the present invention.

FIG. 3 is a rear, right perspective view of the fence post cap according to an embodiment of the present invention.

FIGS. 4A-B are side views of the fence post cap according to multiple embodiments of the present invention.

FIG. 5 is bottom view of the fence post cap according to an embodiment of the present invention.

FIGS. 6A-B show the installation of the fence post cap on the post according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a fence post cap.

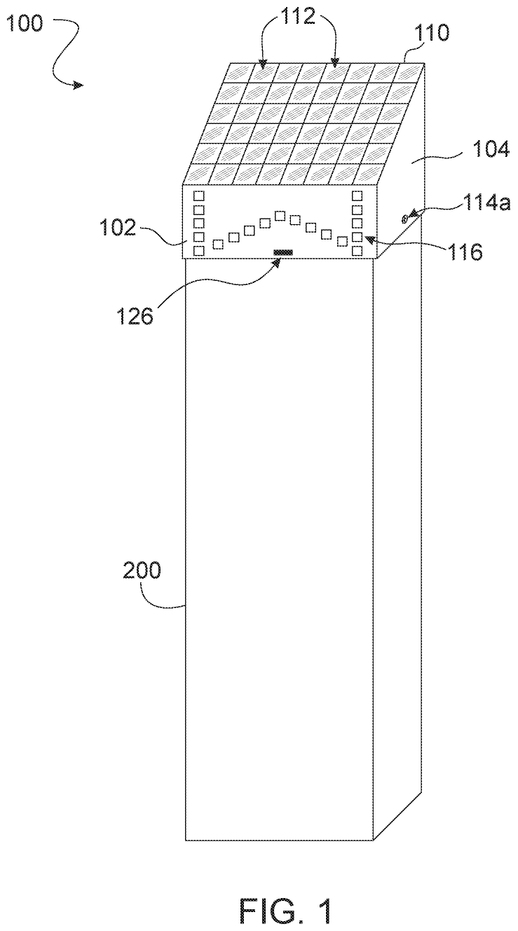

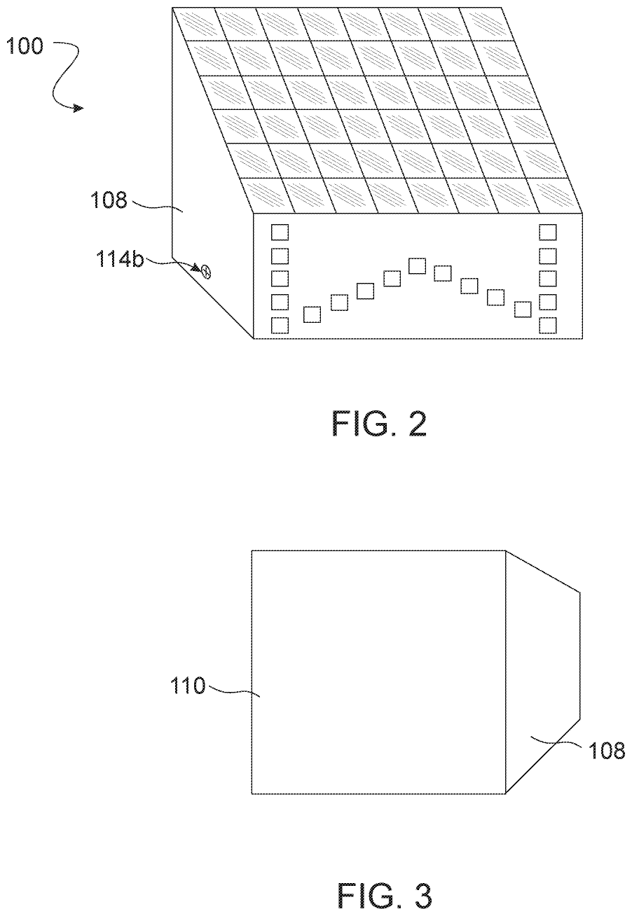

Referring now to FIGS. 1-3, various views of a fence post cap 100 is illustrated. In one embodiment, the fence post cap is constructed from a square base comprising a front side 102, left side 104, rear side 106, and a right side 108. A single top sloped top surface 110 joins the sides. In one embodiment, the single top sloped top surface 110 is pitched from the front side 102 to the rear side 106. Although a square base is provided, in alternative embodiments, a rectangular base may be provided. The fence post cap 100 is configured to be installed on a top portion of a post 200. The single top sloped top surface is configured to direct rainfall off the fence post cap. In one embodiment, a pair of holes 114a and 114b are provided in the center of the left side 104 and right side 108 respectively. Fastening mechanisms, such as screws, may be used to fasten the fence post cap 100 to the post 200.

In some embodiments, a lighting system may be provided. The lighting system comprises a solar panel and LED lights 116. The solar panel comprises a number of photo-voltaic modules 112. The solar panel is situation on the top surface 110 of the fence post cap 100. Since the top surface is sloped in only one direction, consideration of installation direction for the fence post cap may be considered based on the geographic location of the invention to maximum effective sunlight absorption. The number of photo-voltaic modules 112 are configured to provide the energy to the LED lights 116. Electronic components 124 (FIG. 5) are provided to facilitate the energy transfer and storage (battery) of the lighting system. It should be understood, that the placement and arrangement of LED lights are an exemplary instance and may vary. In some embodiments, a motion sensor 126 is provided, wherein the motion sensor is configured to turn on the LED lights when a person is approximate the fence post cap 100. This helps to save the energy (battery) captured via the solar panel. In one embodiment, the motion sensor is positioned on the front side 102 of the fence post cap 100. In some embodiments, the lighting system comprises a light meter (not illustrated) to prevent the LED lights from turning on in the daytime, such that they are only operational in low-light conditions. It should also be understood, that the lighting system is optional.

In one embodiment, the fence post cap, and particularly the base of the fence post cap including the top surface (under the optional solar panel) is constructed from a variety of material including but not limited to plastic, aluminum, and copper. In one embodiment, the plastic construction may be provided in various colors including but not limited to brown, tan, green, and black. Similar, the aluminum construction may be provided in various colors including but not limited to brown, tan, green, and black. It is intended to produce a fence post cap 100 of a specific material and color without and without the lighting system. However, the top surface must only have a single sloped surface, and not contain multiple slopes. Multiple slopes may prevent efficient water runoff and are more expensive to produce.

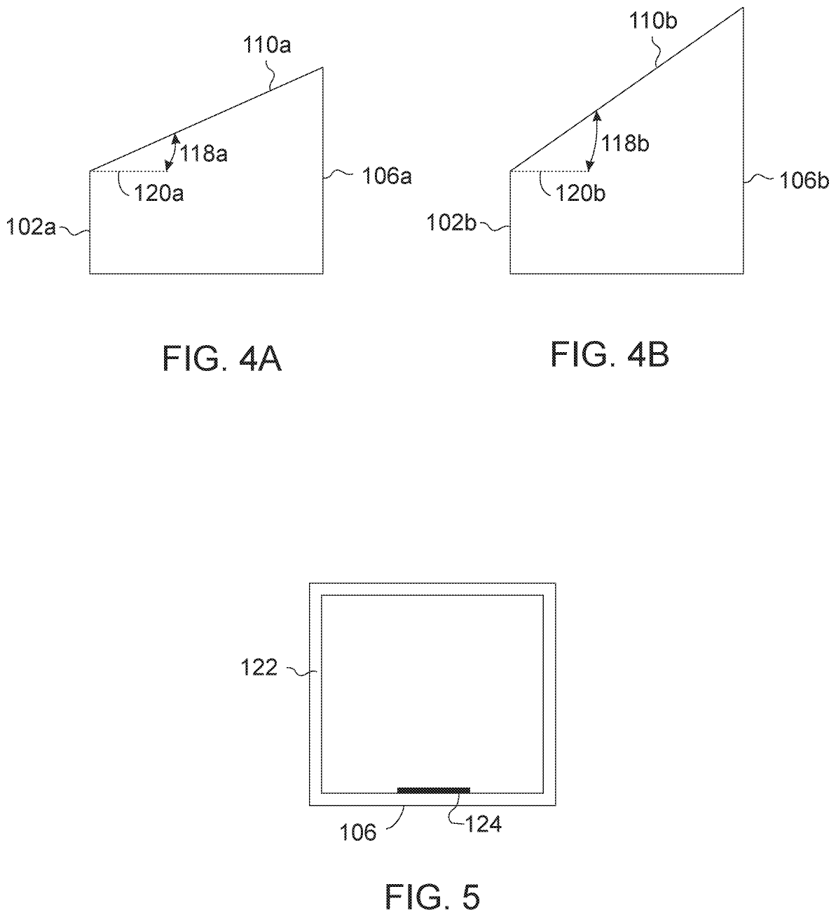

FIGS. 4A-B are side views of the fence post cap 100 according to multiple embodiments of the present invention. Referring now to FIGS. 4A-B, the side views of the left side 104 of the fence post cap are illustrated. As one in the skilled art can realize, the angle (118a/b) of the single slope top surface 110a/b may vary. The angle 118a/b is defined from a hypothetical plane 120a/b perpendicular from the front surface 102a/b to the top surface 110a/b. In one embodiment, the angle 118a is approximately 25 degrees, which correlates to a front surface 102a having a height of 2 inches, the left size having a length of approximately 4 and ⅝ inches, and a rear surface 106a having a height of 4 inches. In this embodiment, the square base would be approximately 4 and ⅝ inches long/wide on each side of the fence post cap 100. In another embodiment, the angle 118b is approximately 45 degrees. Although, two instances of angles are provided, it should be understood that the angle may vary. As the angle varies the height of the rear side as well as the length of the top surface may vary.

Referring now to FIG. 5, a bottom view of the fence post is illustrated. The bottom view illustrates the thickness of each panel of the base of the fence post cap 100. Each panel should ideally the same thickness. In this view, the hollow inside of the base can be visualized exposing the electronic components 124. The electronic components should be positioned on the underside of the top surface towards the rear side 106 such that the electronic components are not damaged or in the way during installation. The installation will be discussed in further detail below.

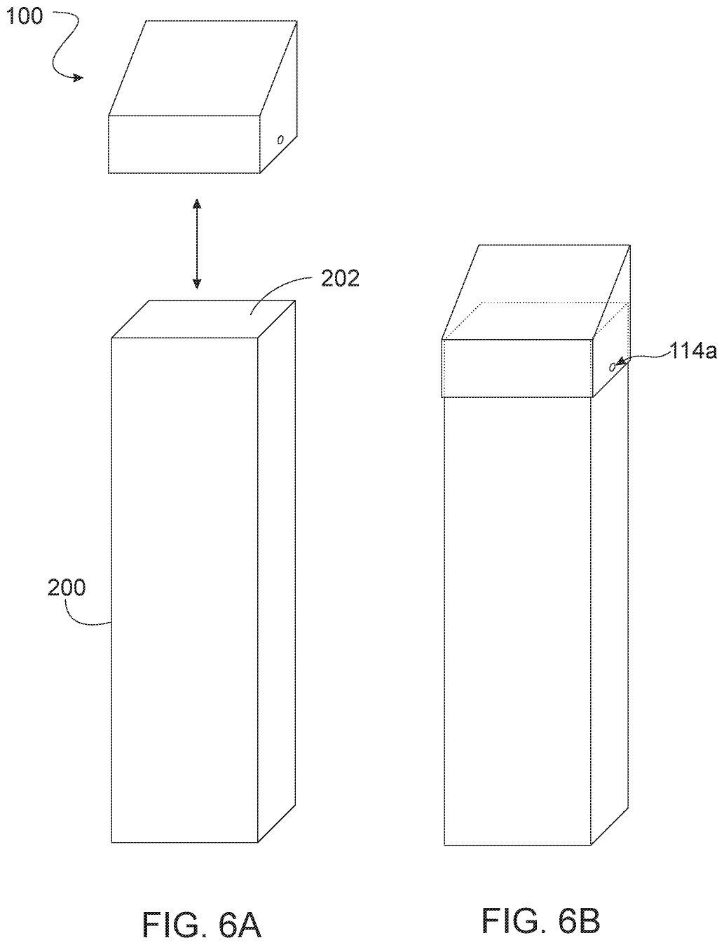

FIGS. 6A-B show the installation of the fence post cap 100 on the post 200 according to an embodiment of the present invention. Referring now to FIGS. 6A-B, the fence post cap 100 is positioned over the top portion 202 of the post 200. The holes 114a/b allow for fastening elements, such as screws, to secure the fence post cap 100 to the post 200. The number of holes and fastening elements may vary as needed.

As mentioned, the size of the fence post cap may vary. Usually this is dependent on the size of the post. Various post sizes are possible, including but not limited to 4 inch by 4 inch, 6 inch by 6 inch, and 8 inch and 8 inch. As previously mentioned, as other sizes and shapes are possible, as long as a single sloped top surface is provided.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

1. A fence post cap consisting of:
a base member having a front side, rear side, a left side, and rear side, wherein the base member is hollow;
a single top sloped surface, wherein the single top sloped surface is pitched from the front side to the rear side; and,
a perpendicular plane extending from the front side to the single top sloped surface defining an angle.

2. The fence post cap of claim 1, further comprising a lighting system, wherein the lighting system comprises a solar panel consisting of a number of photo-voltaic modules, a number of LED lights, a battery, and a motion sensor.

3. The fence post cap of claim 2, wherein the solar panel is positioned on the single top sloped surface.

4. The fence post cap of claim 2, wherein the LED lights and motion sensor are positioned on the front side of the base member.

5. The fence post cap of claim 1, wherein the fence post cap is constructed of aluminum, plastic, or copper.

6. The fence post cap of claim 1, wherein the base member is square.

7. The fence post cap of claim 1, wherein the angle ranges from 25 to 45 degrees.

8-13. (canceled)

14. The fence post cap of claim 1, further comprising a number of holes is provided on the base member enabling a number of fastening elements to pass through the number of holes such that the fence post cap is enabled to be secured to a wood fence post
